(19) United States
(12) Patent Application Publication
(10) Pub. No.: US 2025/0164036 A1
(43) Pub. Date: May 22, 2025

(54) MANIFOLD SYSTEM

(71) Applicant: Cooper-Standard Automotive Inc, Northville, MI (US)

(72) Inventors: Jacob C. Jensen, Northville, MI (US); Jesse Richard Whipkey, Oscoda, MI (US); José Luis Saucedo Mireles, Coahuila (MX)

(73) Assignee: Cooper Standard Automotive Inc., Northville, MI (US)

(21) Appl. No.: 18/512,764

(22) Filed: Nov. 17, 2023

(51) Int. Cl. F16L 3/13; F16L 3/12; F16L 3/22

(52) U.S. Cl. CPC F16L 3/13; F16L 3/1226; F16L 3/221

(57) ABSTRACT

Disclosed herein is a structure for supporting conduit having a generally cylindrical outer surface. The structure has a wall having a wall having a generally U-shaped cross section with a first lateral edge and a second lateral edge opposed to the first lateral edge, a first end, an opposed second end, and a curved surface connecting the first lateral edge to the second lateral edge, a conduit retention member on each of the first end and the second end, the conduit retention member including a hold-down extending inwardly from one of the first lateral edge or the second lateral edge and a release surface on an opposing portion of the first lateral edge or the second lateral edge.

### FIELD

The present disclosure relates generally to clips adapted to support tubes such as lines carrying fluids. More particularly, the disclosure relates to molded plastic clips for use in transportation vehicles including automobiles, trucks, aircraft and the like to support fluid lines for cooling, braking, transmission, fuel systems, and the like.

### BACKGROUND

Flexible plastic tubing or rubber hose is commonly used in vehicles such as automobiles, trucks, construction and excavation machines, and others to convey fluids between various components to enable operation, for example, an engine, a battery, and power equipment associated with the vehicle. Such tubing is typically held in place along a desired path between components using circumferential plastic or metal retaining clips. Plastic tubing may require thermoforming of the tubing in fixtures and rubber hose may need to be cured on shaped mandrels to create and maintain the desired shape and routing path among other equipment in the vehicle. These additional forming steps can be both labor and capital intensive. Accordingly, an improved clip which reduces or eliminates the need for additional forming steps and reduces vehicle weight while providing a secure support and routing structure would be desirable.

### SUMMARY

Disclosed herein is a structure for supporting a conduit having a generally curved outer surface. The structure has a wall with a generally U-shaped cross section with a first lateral edge and a second lateral edge opposed to the first lateral edge, a first end, an opposed second end, and a curved surface connecting the first lateral edge to the second lateral edge. A conduit retention member is present on the first end and/or the second end. The conduit retention member has a hold-down extending inwardly from one of the first lateral edge or the second lateral edge and a release surface on an opposing portion of the first lateral edge or the second lateral edge.

Also disclosed herein is a structure for supporting conduit having a generally curved outer surface. The structure has a wall with a first end and a second end opposed to the first end and a generally U-shaped cross section. The wall has a first track and a second track adjacent to the first track. The first track has a first lateral edge and a second lateral edge opposed to the first lateral edge, and a first curved surface connecting the first lateral edge to the second lateral edge. A first hold-down extends inwardly from one of the first lateral edge or the second lateral edge and a first release surface is present on an opposing portion of the first lateral edge or the second lateral edge. The second track has a third lateral edge and a fourth lateral edge opposed to the third lateral edge. The second track has a second curved surface connecting the third lateral edge to the fourth lateral edge. A second hold-down extends inwardly from one of the third lateral edge or the fourth lateral edge and a second release surface extends from the third lateral edge or the fourth lateral edge.

Also disclosed herein is a structure for supporting conduit having a generally curved outer surface. The structure has a wall having a first end and a second end opposed to the first end and a generally U-shaped cross section. The structure has a first track and a second track adjacent to the first track. The first track has a first lateral edge and a second lateral edge opposed to the first lateral edge, a first end, an opposed second end, and a first curved surface connecting the first lateral edge to the second lateral edge. The second track has a third lateral edge and a fourth lateral edge opposed to the third lateral edge, and a second curved surface connecting the third lateral edge to the fourth lateral edge. A first conduit retention member is positioned between the first track and the second track on the first end and includes a hold-down extending inwardly over the first track and a release surface facing the second track. A second conduit retention member is positioned between the first track and the second track on the second end including a hold-down extending inwardly over the second track and a release surface facing the first track.

Other features and advantages of the invention will be apparent from the following specification taken in conjunction with the following Figures.

### BRIEF DESCRIPTION OF THE DRAWINGS

To understand the present disclosure, it will now be described by way of example, with reference to the accompanying drawings in which:

FIG. 1 is a perspective view of an embodiment of a manifold clip.

FIG. 2 is a perspective side view of the manifold clip of FIG. 1.

FIG. 3 is a perspective end view of the manifold clip of FIG. 1.

FIG. 4 is a perspective top view of the manifold clip of FIG. 1.

FIG. 5 is a perspective view of a two-track embodiment of a manifold clip.

FIG. 6 is a perspective view of another two-track embodiment of a manifold clip.

FIG. 7 is a perspective view of a four-track embodiment of a manifold clip.

FIG. 8 is a perspective view of a four-track array embodiment of a manifold clip.

FIG. 9 is a perspective view of an embodiment of a fluid conveyance system and assembly.

FIG. 10 is a perspective view of a conduit secured with a four-track manifold clip.

### DETAILED DESCRIPTION

While this disclosure is susceptible of embodiments in many different forms, there is shown in the drawings and will herein be described in detail preferred embodiments of the invention with the understanding that the present disclosure is to be considered as an exemplification of the principles of the disclosure and is not intended to limit the broad aspect of the disclosure to the embodiments illustrated.

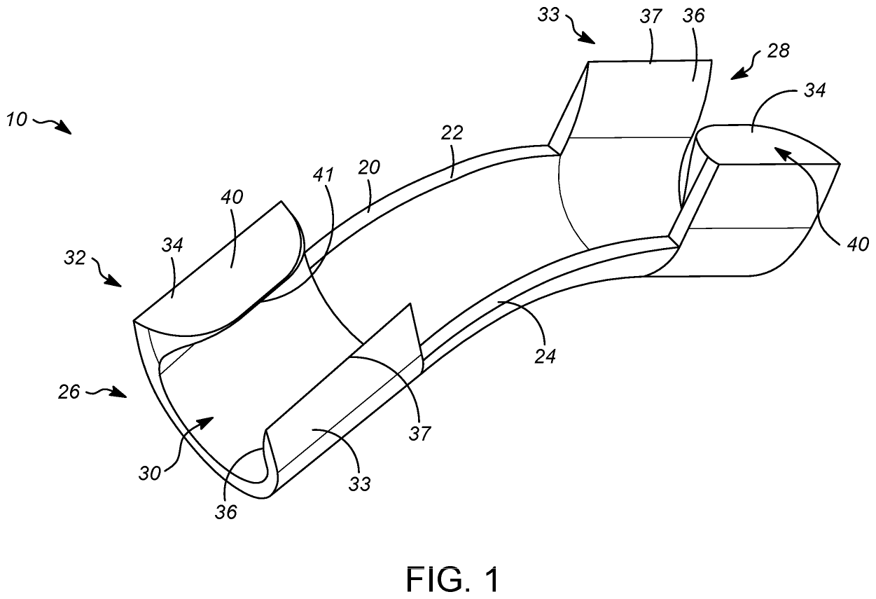

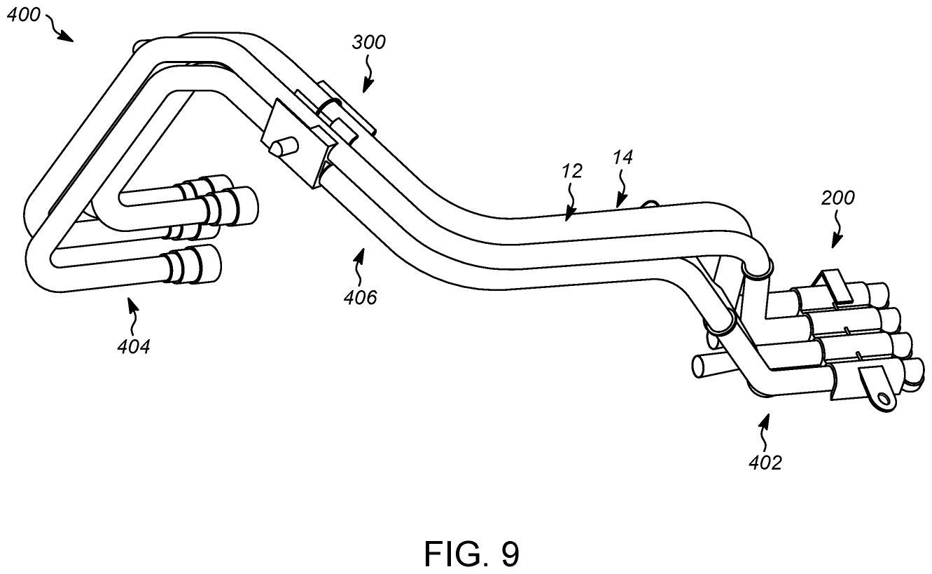

FIG. 1 shows an embodiment of a single-track manifold clip 10 for supporting a conduit 12 which can be viewed in FIG. 9, having a generally circular outer surface 14. While the single-track manifold clip 10 has one track, additional tracks can be provided such that the number of tracks can be from 1 to 10, more preferably from 1 to 8, and most preferably from 1 to 6. The wall 20 has a first lateral edge 22 and a second lateral edge 24 opposed to the first lateral edge 22 and a curved surface 30 connecting the first lateral edge 22 to the second lateral edge 24. The curved surface 30 is generally round in cross-sectional dimension and is said to have a generally U-shape. The curved surface 30 extends a fractional portion of a full circle from 20% to 80%, more preferably from 30% to 70%, even more preferably from 40% to 60%, and most preferably from 45% to 55%. The U-shaped surface 30 is generally round in cross-sectional shape and has a diameter that can vary in dimension to accommodate an outer diameter of a conduit. Conduit outer diameters in the automotive industry for conveying fluids in an automobile or truck typically fall within a range of from 6 mm-30 mm outer diameter.

The wall 20 also has a first end 26 and an opposed second end 28. A first conduit retention member 32 is present on the first end 26 and a second conduit retention member 33 is present on the second end 28. The first conduit retention members 32 has a hold-down 34 extending inwardly from the first lateral edge 22 and a release surface 36 is present on the second lateral edge 24. The second conduit retention member 33 has the hold-down extending inwardly from the second lateral edge 24 and the release surface 36 extending from the first lateral edge 22. Thus, the first conduit retention member 32 and the second conduit retention member 33 may be mirror images of each other each having the reverse orientation from each other.

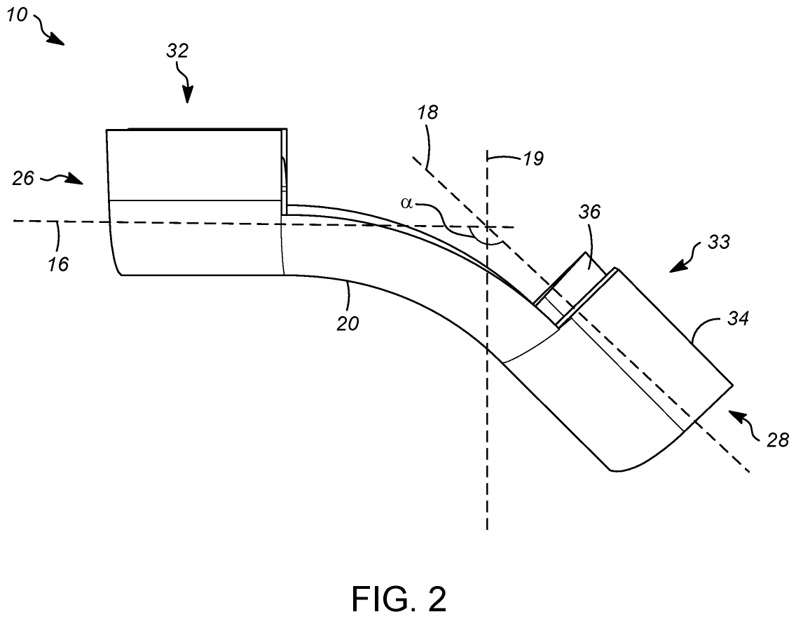

FIG. 2 shows the wall 20 is longitudinally radiused so that the first end 26 and the second end 28 are not coplanar. The degree of radius is measured by extending an axis 16 through the conduit retention member 32 at the first end, extending an axis 18 through the conduit retention member 32 at the second end 28, and extending a vertical axis 19 through both the first and second axes at 90° to the first axis 16. An angle α between the second axis 18 and the first axis 16 is measured and by subtracting 90° the degree of radius is obtained. In this instance, the angle α is 135°, and therefore, the degree of radius is 45°. However, it should be understood, the degree of radius could be from 0° to 270°, more preferably from 0° to 180°, even more preferably 0° to 135°, and most preferably 0° to 90°. When a is 0° or 180° the degree of radius is 90° and the first end 26 and the second end 28 are said to be “coplanar.” When a is any other angle other than 0° or 180°, then the first end 26 and the second end 28 are said to be “not coplanar.” The degree of radius can also be expressed as a percentage of the outer diameter “OD” of the tube with a minimum of 1.25×OD. By incorporating the desired angles into the clip, the need for a tubing thermoforming step is eliminated.

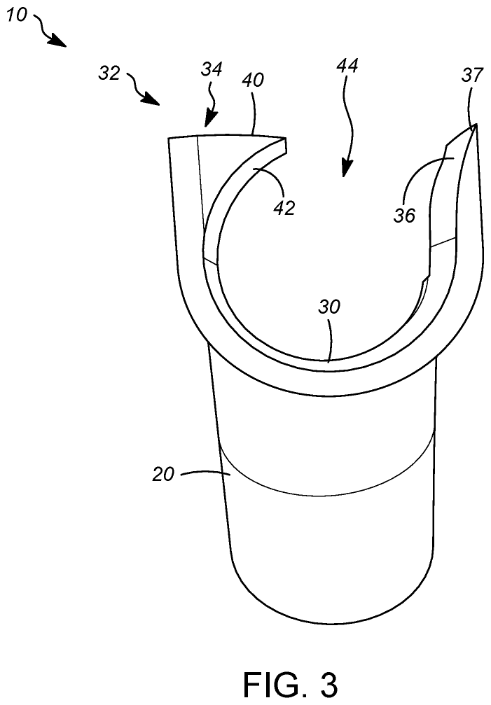

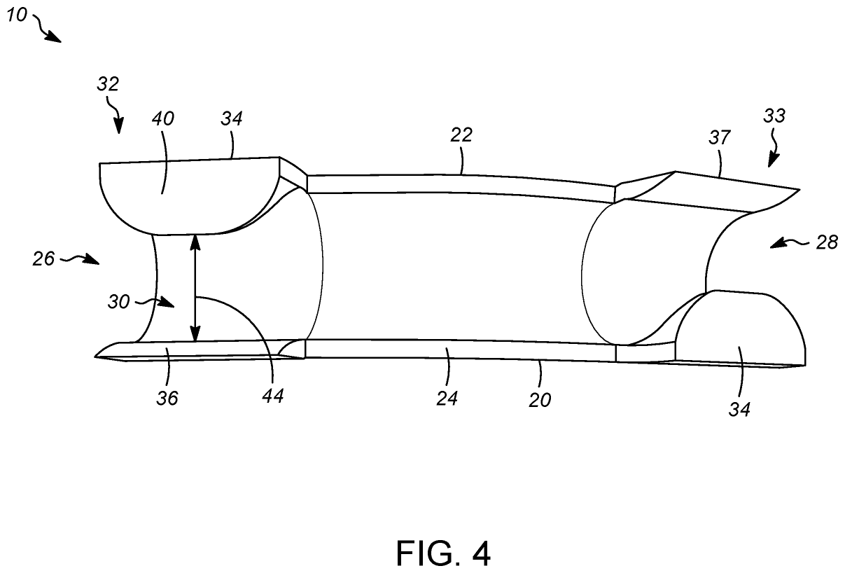

FIGS. 3 and 4 also show the hold-down 34 has an upper surface 40 that is flat and a lower surface 42 that is curved. The upper surface 40 extends radially inwardly a fraction of the diameter of the U-shaped surface 30 leaving a gap 44 between a distal end 41 of the upper surface 40 and the release surface 36. In one embodiment, the upper surface 40 extends from 10% to 80%, more preferably 30% to 80%, and most preferably from 60% to 80%. The release surface 36 is tapered outwardly to form a thinned distal end 37. FIG. 3 shows the U-shaped surface 30 is generally round in cross-sectional shape and has a diameter that can vary in dimension to accommodate an outer diameter of a conduit.

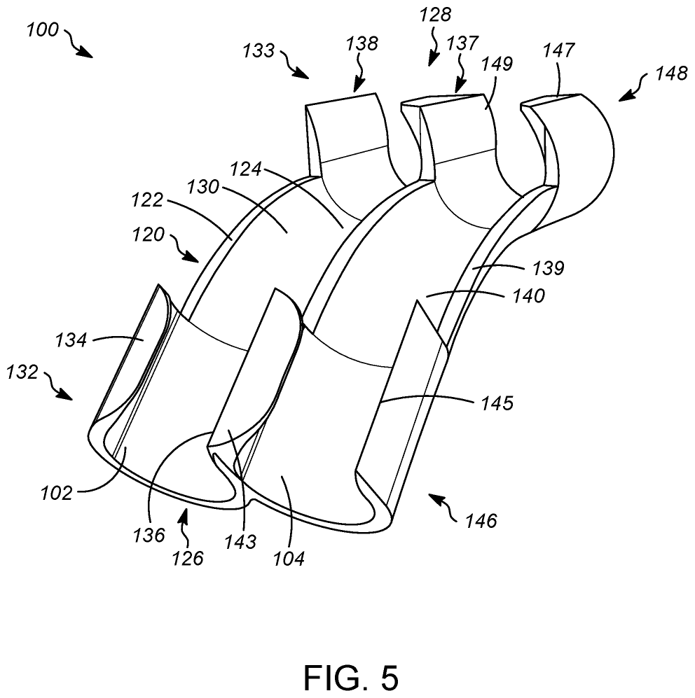

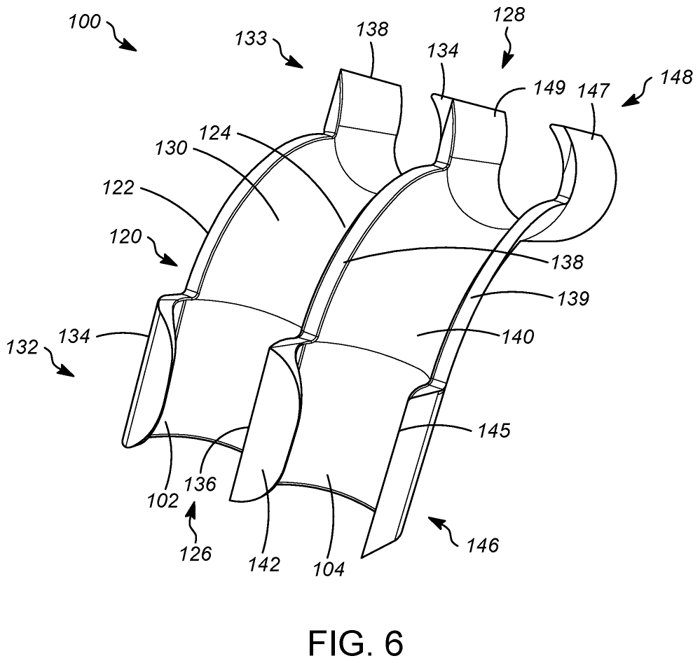

FIGS. 5 and 6 show a two-track clip embodiment 100 having a first track 102 and a second track 104 that, preferably, extend parallelly and coextensively with one another. The first track 102 and the second track 104 are the same as the single-track embodiment 10 in terms of measuring the angle α, calculating the degree of radius, and the ranges set forth above for these parameters. FIG. 5 shows a two-track clip 100 having a degree of radius of 45° and FIG. 6 shows a two-track clip having a degree of radius of 90°.

The two-track clip 100 has a wall 120 with a first end 126 and a second end 128 opposed to the first end and a generally U-shaped cross section as defined above. The first track 102 has a first lateral edge 122 and a second lateral edge 124 opposed to the first lateral edge, and a first curved surface 130 connecting the first lateral edge 122 to the second lateral edge 124. The curved surface 130 extends a fractional portion of a full circle in the ranges set forth above. A first conduit retention member 132 is on the first end 126 and a second conduit retention member 133 is on the second end 128.

The first conduit retention members 132 has a first hold-down 134 extending inwardly from the first lateral edge 122 and a first release surface 136 is present on the second lateral edge 124. The second conduit retention member 133 has the second hold-down 137 extending inwardly from the second lateral edge 124 and the second release surface 138 extending from the first lateral edge 122. Thus, the first conduit retention member 132 and the second conduit retention member 133 are mirror images of each other each having a reverse orientation to the other.

The second track 104 shares the second lateral edge 124 with the first track 102 and has a third lateral edge 139 opposed to the second lateral edge 124. The second track 104 has a second curved surface 140 connecting the second lateral edge 124 to the third lateral edge 139. The curved surface 140 extends a fractional portion of a full circle in the ranges set forth above. Typically, the second curved surface 140 extends the same fractional portion of a full circle as the first curved surface 130. A third conduit retention member 146 is present on the second track 104 at the first end 126 and a fourth conduit retention member 148 is present on the second track 104 at the second end 128. The third conduit retention member 146 has a third hold-down 143 extending inwardly from the second lateral edge 124 to the second track 104 and a third release surface 145 is present on the third lateral edge 139. The fourth conduit retention member 148 has a fourth hold-down 147 extending inwardly from the third lateral edge 139 and a fourth release surface 149 extending from the second lateral edge 124. Thus, the third conduit retention member 146 and the fourth conduit retention member 148 are mirror images of each other each having a reverse orientation to the other.

FIGS. 5 and 6 show on the second lateral edge 124 shared by the first track 102 and the second track 104, the hold down and the release surfaces are integral or even unified with each other. On the first end 126 the first release surface 136 is integral with the third hold-down 143 on the shared second lateral edge 124 but facing in opposite directions toward their respective track. The first release surface 136 faces the first track 102, and the third hold-down 143 extends over the second track 104. On the second end 128 the fourth release surface 149 is integral with the second hold-down 137 on the shared second lateral edge 124 but facing in opposite directions toward their respective track. On the second end 128 the second hold-down 137 faces and extends over the first track 102 and the second release surface 149 faces the second track 104.

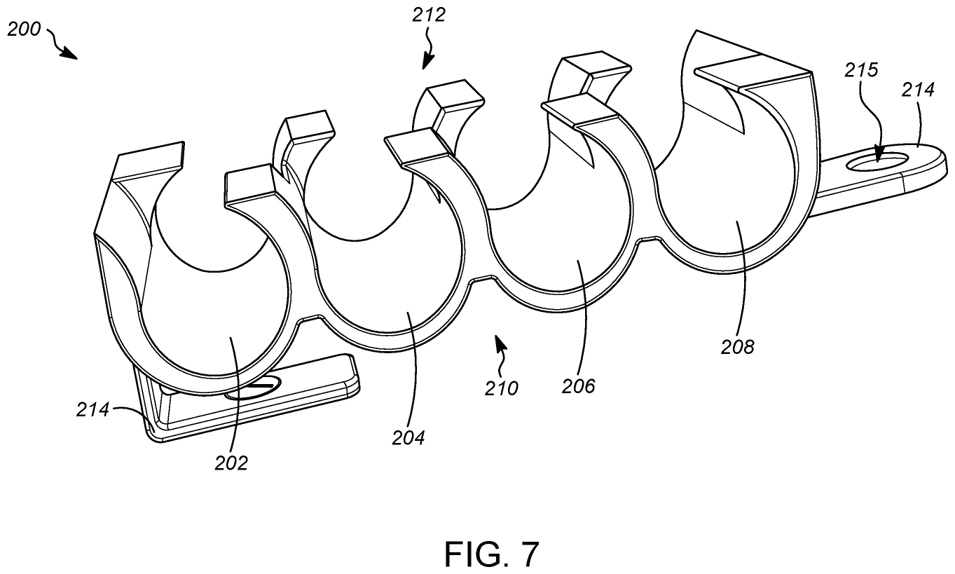

FIG. 7 shows a four-track clip 200 having a first track 202, a second track 204, a third track 206, and a fourth track 208 all running parallel and coextensive with one another. The four tracks can be configured and dimensioned as described above with respect to the single-track 10 and the two-track clip 100 embodiments. The degree of radius is 0° and thus the opposed ends 210 and 212 are coplanar. A pair of attachment lugs 214 are provided for securing the clip 200 to a surface. A through hole 215 can be provided on the lugs 214 for receiving a fastener such as a threaded fastener or nail to attach to a surface, for example, inside an engine compartment or other location.

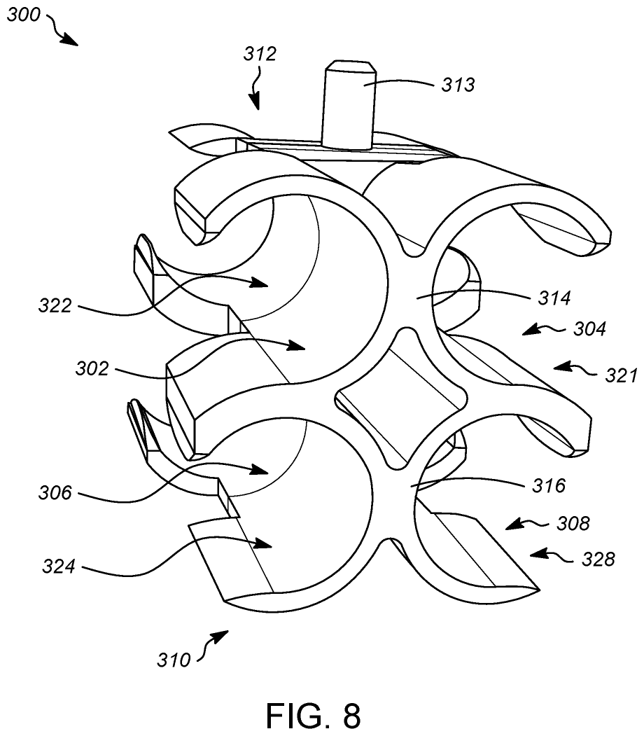

FIG. 8 shows a four-track array clip 300 having a first track 302, a second track 304, a third track 306, a fourth track 308, a first end 310, a second end 312, and an attachment member 313. The four tracks can be configured and dimensioned as described above with respect to the single-track 10 and two-track clip 100 embodiments. The tracks are shown disposed in an array of rows and columns. In this embodiment, two rows and two columns are shown. It is contemplated that the number of rows and columns can be the same number or a different number selected from the ranges of from 2 to 10, more preferably from 2 to 8, even more preferably from 2 to 6, and most preferably from 2 to 4. The first track 302 extends parallel and coextensive with the second track 304 and together form a first row 314. A gap 320 in the first track 302 faces to the left and a gap 321 in the second track 304 faces to the right and the first track and the second track abut one another at a valley 322 in both U-shaped walls. The third track 306 extends parallel and coextensive with the fourth track 308 and together form a second row 316. The first row 314 is connected to the second row 316 in vertical spaced relationship. A gap 324 in the third track 306 faces to the left and a gap 328 in the fourth track 308 faces to the right and the third track and the fourth track abut one another at a valley 330 in both U-shaped walls. The first and second tracks 302, 304 have a degree of radius of 90°, and therefore, are coplanar. Similarly, the third track 306 and the fourth track 308 have a degree of radius of 90°, and therefore, are coplanar.

The manifold clips can be made of a polymeric material and formed by injection molding, thermoforming, or other polymeric processing techniques well known to those or ordinary skill in the art. Suitable polymeric materials include polyvinyl chloride (PVC), polyolefin, polyamide, polyester, polyethylene terephthalate (PET), cyclic olefin copolymer (COC) or other.

FIG. 9 shows a fluid conveyance system 400 with four fluid conduits 12 extending from a first location 402 to a second location 404 through a third location 406 between the first location 402 and the third location 406. In the first location 402, the four fluid conduits 12 extend in parallel spaced relationship and are coplanar. The fluid conduits are preferably flexible, made from a polymeric material, and the outer surface is smooth or corrugated. Suitable conduit includes clear vinyl tubing and corrugated tubing. Suitable polymeric material includes polyvinyl chloride (PVC), polyolefin, polyamide, polyester, polyethylene terephthalate (PET), cyclic olefin copolymer (COC) or others. A four-track clip 200 of FIG. 7 is clipped to the conduits by inserting one conduit into each of the four tracks 202-208 to hold them in a desired location and orientation. The mounting lugs 214 can be attached to a surface using a fastener such as a screw. The surface can be located, for example, in an engine bay of a transport vehicle to convey fluids from one component to another component in a cooling system, braking system, power steering system, battery cooling, or other. In the second location 404 the four conduits are disposed in a two-by-two array and a four-track array clip 300 of FIG. 8 to which the conduits are mounted with one conduit in one of each of the four tracks 302-308.

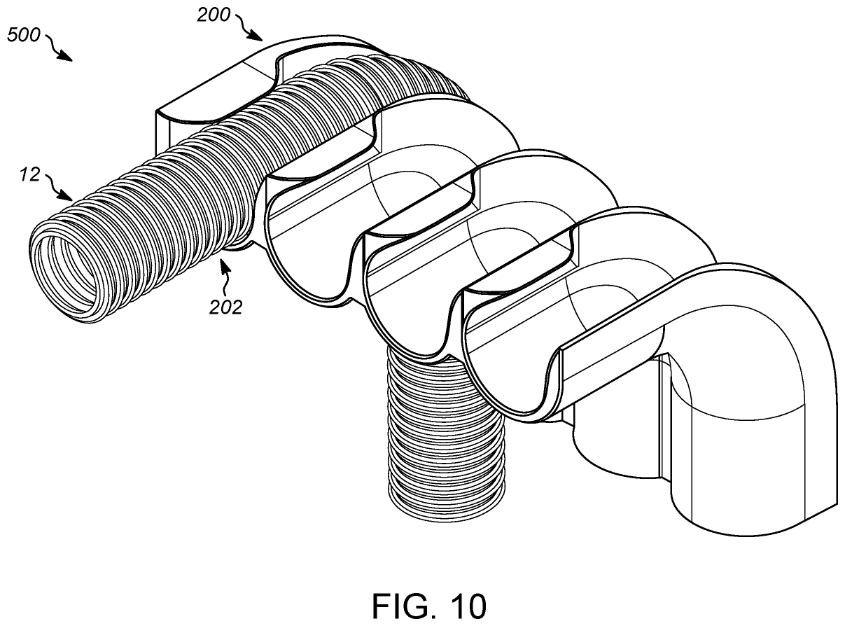

FIG. 10 shows an assembly 500 of a four-track clip 200 with a degree of radius of 90° and a corrugated tubing 12 inserted into the first track 202. To insert a conduit 12 into a track of a clip the conduit is oriented at an acute angle over the track at one end and is pressed into the gap 44 until it is fully seated as shown in FIG. 10. Then a second portion of the conduit is placed over an opposed end of the conduit at an acute angle and is pressed into the gap 44 until it is fully seated.

Many modifications and variations of the present invention are possible in light of the above teachings. It is, therefore, to be understood within the scope of the appended claims the invention may be protected otherwise than as specifically described.

1. A structure for supporting conduit having a generally cylindrical outer surface, the structure comprising:
a wall having a generally U-shaped cross section with a first lateral edge and a second lateral edge opposed to the first lateral edge, a first end, an opposed second end, a continuous opening into the wall from the first end to the second end to receive the conduit, and a curved surface connecting the first lateral edge to the second lateral edge, a conduit retention member on one of the first end and the second end, the conduit retention member comprising a hold-down extending inwardly from one of the first lateral edge or the second lateral edge a fraction of the diameter of the U-shaped cross section, a release surface on an opposing portion of the first lateral edge or the second lateral edge, and a gap between the hold-down and the release surface.

2. The structure of claim 1 wherein the hold-down has a generally flat upper surface.

3. The structure of claim 2 wherein the hold-down has a generally curved lower surface opposed to the upper surface.

4. The structure of claim 1 wherein the release surface is tapered outwardly at a distal end.

5. The structure of claim 1 wherein the first end is coplanar with the second end.

6. The structure of claim 1 wherein the first end is not coplanar with the second end.

7. The structure of claim 6 wherein the wall has a degree of radius from 0° to 270°.

8. A structure for supporting conduit having a generally curved outer surface, the structure comprising:
a wall having a first end and a second end opposed to the first end and a generally U-shaped cross section, a continuous opening into the wall from the first end to the second end to receive the conduit, a first track and a second track adjacent to the first track;
the first track having a first lateral edge and a second lateral edge opposed to the first lateral edge, and a first curved surface connecting the first lateral edge to the second lateral edge, a first hold-down extending inwardly from one of the first lateral edge or the second lateral edge a fraction of the diameter of the U-shaped cross section, a first release surface on an opposing portion of the first lateral edge or the second lateral edge, and a gap between the hold-down and the release surface; and,
the second track comprising the second lateral edge and a third lateral edge opposed to the second lateral edge, and a second curved surface connecting the second lateral edge to the third lateral edge, a second hold-down extending inwardly from one of the second lateral edge or the third lateral edge and a second release surface extending from the second lateral edge or the third lateral edge.

9. The structure of claim 8 wherein the first hold-down has a generally flat upper surface.

10. The structure of claim 9 wherein the first hold-down has a generally curved lower surface opposed to the upper surface.

11. The structure of claim 8 wherein the first release surface is tapered outwardly at a distal end.

12. The structure of claim 8 wherein the first hold-down extends from the first lateral edge and faces the first track and the first release surface extends from the second lateral edge and faces the first track.

13. The structure of claim 12 wherein the second hold-down extends from the second lateral edge and faces the second track.

14. The structure of claim 13 wherein the second release surface extends from the third lateral edge and faces the second track.

15. A structure for supporting conduit having a generally curved outer surface, the structure comprising:
a wall having a first end and a second end opposed to the first end and a generally U-shaped cross section, a continuous opening into the wall from the first end to the second end to receive the conduit, with a first track and a second track adjacent to the first track;
the first track having a first lateral edge and a second lateral edge opposed to the first lateral edge, a first end, an opposed second end, and a first curved surface connecting the first lateral edge to the second lateral edge;
the second track comprising the second lateral edge and a third lateral edge opposed to the second lateral edge, and a second curved surface connecting the second lateral edge to the third lateral edge;
a first conduit retention member between the first track and the second track on the first end comprising a hold-down extending inwardly over the first track a fraction of the diameter of the U-shaped cross section, a release surface facing the second track, and a gap between the hold-down and the release surface; and,
a second conduit retention member between the first track and the second track on the second end comprising a hold-down extending inwardly over the second track and a release surface facing the first track.

16. The structure of claim 15 wherein the hold-down has a generally flat upper surface.

17. The structure of claim 16 wherein the hold-down has a generally curved lower surface opposed to the upper surface.

18. The structure of claim 15 wherein the release surface is tapered outwardly at a distal end.

19. The structure of claim 15 wherein the first end is coplanar with the second end.

20. The structure of claim 15 wherein the wall has a degree of radius from 0° to 270°.
